(19) United States
(12) Patent Application Publication
(10) Pub. No.: US 2013/0070291 A1
(43) Pub. Date: Mar. 21, 2013

(54) IMAGE PROCESSING APPARATUS

(71) Applicant: Takashi NISHIZAKI, Nagoya-shi (JP)

(72) Inventor: Takashi NISHIZAKI, Nagoya-shi (JP)

(73) Assignee: BROTHER KOGYO KABUSHIKI KAISHA, Nagoya-shi (JP)

(21) Appl. No.: 13/422,889

(22) Filed: Mar. 16, 2012

(30) Foreign Application Priority Data
Sep. 20, 2011 (JP) 2011-205185

(51) Int. Cl. G06K 15/02

(52) U.S. Cl. 358/1.15

(57) ABSTRACT

A non-transitory computer-readable medium having a computer program stored thereon and readable by a computer, the computer program, when executed by the computer, causes a computer to perform operations including: a process of displaying a setting screen; a process of getting information about a correspondence function from a managing unit, the managing unit managing a display condition including an execution condition, which is satisfied when a specific instruction is designated by a user through the setting screen, and the functions in association with each other, and the correspondence function being associated with the display condition; and a process of, when the display condition is satisfied when a specific instruction is designated, displaying related information relating to the correspondence function on the display unit by using the got information relating to the correspondence function.

### CROSS-REFERENCE TO RELATED APPLICATIONS

This application claims priority from Japanese Patent Application No. 2011-205185 filed on Sep. 20, 2011, the entire subject matter of which is incorporated herein by reference.

### TECHNICAL FIELD

The invention relates to a technology of displaying a setting screen for executing a plurality of functions relating to image processing.

### BACKGROUND

In recent years, a printer has a variety of functions. For example, when performing a printing operation, a plurality of functions such as duplex printing function, 2 in 1 function, toner save function, watermark function and the like may be executed by the printer, in addition to a usual printing function. A user may know the functions by referring to an explanatory pamphlet (manual), a website and the like. However, efforts to check and understand the functions by referring to the explanatory pamphlet (manual), the website and the like are burden for the user. As a result, even when the printer has a function that is convenient to the user, the function may be unused. Patent Document 1 suggests a technology of, when a printer has a function that a user does not use frequently, displaying hint display information indicating contents of the function on a printing setting screen.

### SUMMARY

In the above-described technology of merely displaying the hint display information about the function that is not used frequently by the user, many functions may still be buried without being used. Such a problem is not limited to the printer and is common to other image processing apparatuses (for example, scanner and digital camera).

Therefore, illustrative aspects of the invention provide technology of suppressing a function of an image processing apparatus from being unused.

The invention has been made to solve at least a part of the above problem and can be realized as following illustrative aspects.

According to one illustrative aspect of the invention, there is provided a non-transitory computer-readable medium having a computer program stored thereon and readable by a computer for displaying a setting screen for inputting an execution instruction to an image processing apparatus configured to execute a plurality of functions relating to image processing. The computer program, when executed by the computer, causes a computer to perform operations comprising: a first displaying process of displaying the setting screen on a display unit; a getting process of getting information about a correspondence function from a managing unit, wherein the managing unit manages a display condition including an execution condition, which is satisfied when a specific instruction is designated by a user through the setting screen, and the functions in association with each other, and wherein the correspondence function is a function that is associated with the display condition; and a second displaying process of, when a using frequency of the correspondence function is lower than a predetermined value, which is a case where the display condition is satisfied when the specific instruction is designated, displaying related information relating to the correspondence function on the display unit by using the got information relating to the correspondence function.

According thereto, when the display condition is satisfied, the related information that corresponds to the display condition and relates to the correspondence function having a using frequency lower than a predetermined value is displayed on the display unit. Accordingly, when a specific instruction is designated from the user, the predetermined related information is displayed. Hence, it is possible to enable the user to recognize the effective related information at the timing at which the user instructs the execution. Accordingly, the using of the correspondence function by the user can be promoted. As a result, it is possible to suppress the functions of the image processing apparatus from being buried without being used.

According to another illustrative aspect of the invention, there is provided an image processing apparatus configured to execute a plurality of functions relating to image processing. The image processing apparatus comprises: a display unit; and a control device. The control device is configured to: control the display unit to display a setting screen for receiving an execution instruction of a user; get information about a correspondence function from a memory, wherein the control device is configured to manage a display condition including an execution condition, which is satisfied when a specific instruction is designated by the user through the setting screen, and the functions in association with each other in the memory, and wherein the correspondence function is a function that is associated with the display condition; and when a using frequency of the correspondence function is lower than a predetermined value, which is a case where the display condition is satisfied when the specific instruction is designated, control the display unit to display related information relating to the correspondence function on the display unit by using the got information relating to the correspondence function.

According thereto, when the display condition is satisfied, the related information that corresponds to the display condition and relates to the correspondence function having a using frequency lower than a predetermined value is displayed on the display unit. Accordingly, when a specific instruction is designated from the user, the predetermined related information is displayed. Hence, it is possible to enable the user to recognize the effective related information at the timing at which the user instructs the execution. Accordingly, the using of the correspondence function by the user can be promoted. As a result, it is possible to suppress the functions of the image processing apparatus from being unused.

Incidentally, the invention can be implemented in various aspects and can be implemented in a variety of programs such as device driver installed in a computer terminal apparatus so as to execute processing of the image processing apparatus, in addition to a program for displaying a setting screen of the image processing apparatus. Also, the invention can be implemented in a recording medium in which the program is recorded. Furthermore, the invention can be implemented in an apparatus such as printer, scanner, digital camera, printing system and the like, in addition to the image processing apparatus. Also, the invention can be implemented in various methods such as control method of the image processing apparatus.

### BRIEF DESCRIPTION OF THE DRAWINGS

FIGS. 1A and 1B are block diagrams showing a configuration of an image processing system;

FIG. 2 shows an outline of a performance table;

FIG. 3 shows an example of a condition function correspondence table;

FIG. 4 shows a circumstance list table;

FIG. 5 is a flowchart showing printer driver start-up processing;

FIGS. 6A to 6D show an example of an operation screen;

FIG. 7 is a flowchart showing assist mode printing processing;

FIGS. 8A to 8C show an operation screen when two setting items of a correspondence function are changed;

FIGS. 9A and 9B illustrate navigation moving picture that is related information according to one modified exemplary embodiment; and

FIG. 10 shows an example of a circumstance list table according to another modified exemplary embodiment.

### DETAILED DESCRIPTION

### A. Exemplary Embodiments

### A-1. Configuration of Image Processing System

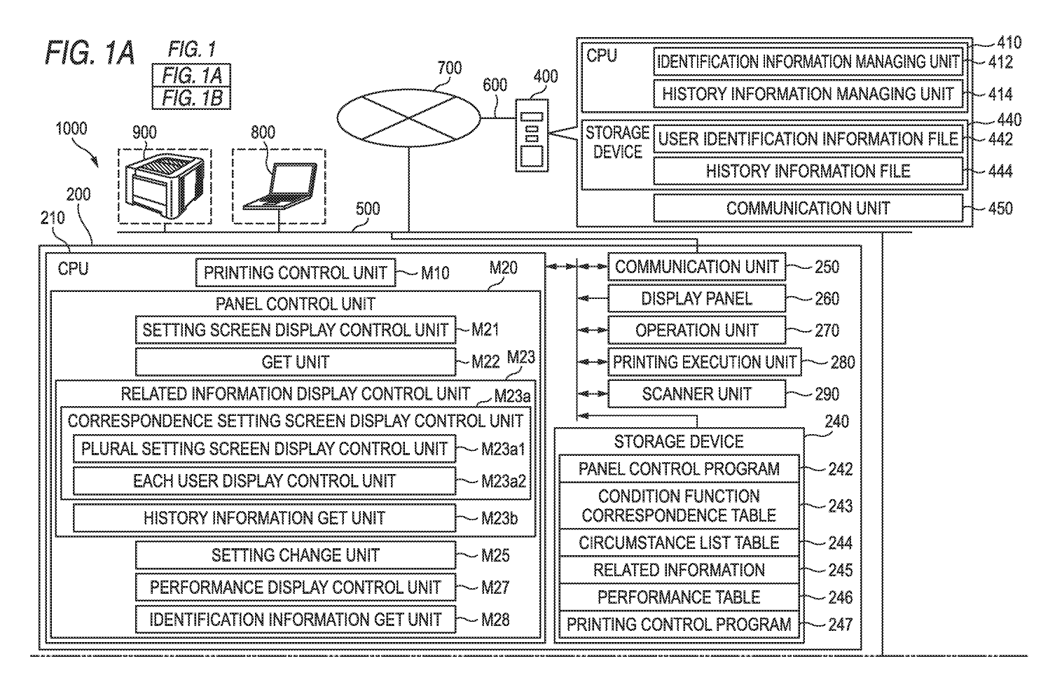

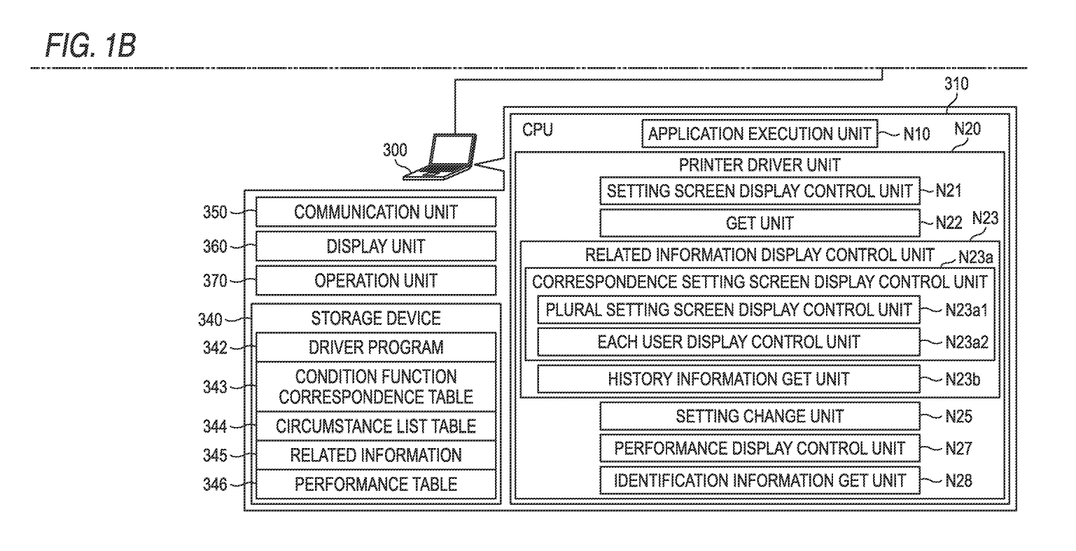

FIG. 1 is a block diagram showing a configuration of an image processing system according to an exemplary embodiment. An image processing system 1000 includes a multi-function device (peripheral device) 200, a personal computer (which is also referred to as a user computing device) 300 and a server 400. The multi-function device 200 and the user computing device 300 are connected to a first LAN (Local Area Network) 500. The server 400 is connected to a second LAN 600. The first LAN 500 and the second LAN 600 are connected to the internet 700.

The user computing device 300 includes a CPU (Central Processing Unit) 310, a storage device 340 such as semiconductor memory and hard disk drive, a communication unit 350 including an interface (I/F) for connection to a network (for example, first LAN 500), a display unit 360 such as liquid crystal display and an operation unit 370 such as keyboard and pointing device.

The storage device 340 stores therein a driver program 342 for the multi-function device 200, a condition function correspondence table 343, a circumstance list table 344, related information 345 and a performance table 346. The storage device 340 also stores therein a variety of programs and data. The programs and data may be also provided in a computer-readable recording medium in which they are recorded. The driver program 342 is a program for enabling the CPU 310 to implement printer driver start-up processing, assist mode printing processing and the like, which will be described later. The condition function correspondence table 343, the circumstance list table 344, the related information 345 and the performance table 346 will be described later.

The CPU 310 executes the programs stored in the storage device 340 so as to function as an application execution unit N10 and a printer driver unit N20. The application execution unit N10 executes a variety of applications.

The printer driver unit N20 can execute the printer driver start-up processing and the assist mode printing processing based on the driver program 342. The printer driver unit N20 gets image data, which indicates an image of a printing object, from the application execution unit N10, for example, by these processing, generates printing data by using the got image data and supplies the generated printing data to the multi-function device 200.

The printer driver unit N20 includes a setting screen display control unit N21, a get unit N22, a related information display control unit N23, a setting change unit N25, a performance display control unit N27 and an identification information get unit N28. The related information display control unit N23 includes a correspondence setting screen display control unit N23a and a history information get unit N23b. Also, the correspondence setting screen display control unit N23a includes a plural setting screen display control unit N23a1 and an each user display control unit N23a2. The processing of the functional modules will be specifically described later in the printer driver start-up processing and the assist mode printing processing.

The multi-function device 200 includes a CPU 210, a storage device 240 such as semiconductor memory and hard disk drive, a communication unit 250 including an interface (I/F) for connection to a network, a display panel 260 such as liquid crystal panel, an operation unit 270 (i.e., various buttons, touch panel and the like) configured to receive an operation of a user, a printing execution unit 280 configured to form an image on a printing medium by a known method (for example, laser, inkjet and the like) and a scanner unit 290 configured to read a document by a known sensor (for example, CIS (Contact Image Sensor)) and generate image data.

The storage device 240 stores therein a panel control program 242, a condition function correspondence table 243, a circumstance list table 244, related information 245, a performance table 246 and a printing control program 247. The storage device 240 also stores therein a variety of programs and data. The programs and data may be also provided in a computer-readable recording medium in which they are recorded. The panel control program 242 is a program for enabling the CPU 210 to implement the printer driver start-up processing, the assist mode printing processing and the like, which will be described later. The condition function correspondence table 243, the circumstance list table 244, the related information 245 and the performance table 246 are the same as the condition function correspondence table 343, the circumstance list table 344, the related information 345 and the performance table 346 that are stored in the storage device 340, respectively.

The CPU 210 executes the panel control program 242 stored in the storage device 240 so as to function as a panel control unit M20. The CPU 210 executes the printing control program 247 so as to functioning as a printing control unit M10. The panel control unit M20 can execute the printer driver start-up processing and the assist mode printing processing based on the panel control program 242.

The printing control unit M10 controls the printing execution unit 280 to execute a printing operation based on a printing request from the printer driver unit N20 or panel control unit M20. Specifically, the printing request from the printer driver unit N20, which is received by the printing control unit M10, includes printing data. The printing control unit M10 supplies the printing data, which is included in the printing request received from the printer driver unit N20, to the printing execution unit 280 to execute the printing. When there is the printing request from the panel control unit M20, the printing control unit M10 gets image data, which corresponds to the printing request from the panel control unit M20, from an external memory (not shown) connected to the multi-function device 200 and generates printing data. The panel control unit M20 supplies the generated printing data to the printing execution unit 280 to execute the printing. Incidentally, the printing control unit M10 may be adapted to get the image data from the scanner unit 290, other than the external memory.

The printing execution unit 280 may execute a plurality of printing functions and a combination of the printing functions. The plurality of printing functions includes a duplex printing function, a black-and-white printing function, a color printing function, a function of printing a plurality of pages on one surface (for example, 2 in 1 function), a printing material saving function (for example, toner save function in a laser printer), a watermark printing function and the like. The panel control unit M20 includes a setting screen display control unit M21, a get unit M22, a related information display control unit M23, a setting change unit M25, a performance display control unit M27 and an identification information get unit M28. The related information display control unit M23 includes a correspondence setting screen display control unit M23a and a history information get unit M23b. The correspondence setting screen display control unit M23a includes a plural setting screen display control unit M23a1 and an each user display control unit M23a2. The respective functional units M21 to M28 of the panel control unit M20 have the basically same functions as the functional units N21 to N28 having the same names in the printer driver unit N20 of the user computing device 300. However, while the respective functional units N21 to N28 of the printer driver unit N20 implement user interfaces on the display unit 360 of the user computing device 300, the respective functional units M21 to M28 of the panel control unit M20 implement user interfaces on the display panel 260 of the multi-function device 200.

The server 400 includes a CPU 410, a storage device 440 and a communication unit 450 including a network interface (I/F). The storage device 440 stores therein a user identification information file 442 and a history information file 444 together with a server program (not shown). The user identification information file 442 is a file in which user identification information for identifying a user of the multi-function device 200 is stored. In this exemplary embodiment, a to login password that is registered for each user is used as the user identification information. The history information file 444 is a file in which history information, which indicates an execution performance of the printing function in the multi-function device 200 (printing execution unit 280), is stored. The history information is stored such that a value of a variable for history recording and a value of a date correspondence variable are associated with each other. The history information is managed for each user ID. That is, each of the user identification information stored in the user identification information file 442 is associated with the history information of one user. The history information (variable for history recording and date correspondence variable) will be specifically described later.

The CPU 410 executes the server program so as to function as an identification information managing unit 412 and a history information managing unit 414.

The identification information managing unit 412 manages the user identification information file 442. Specifically, the identification information managing unit 412 receives the login password from the printer driver unit N20 of the user computing device 300 or panel control unit M20 of the multi-function device 200. The identification information managing unit 412 compares the received login password with the user identification information stored in the user identification information file 442 and thus determines whether or not to permit the login. Also, the identification information managing unit 412 receives a newly registered login password from the printer driver unit N20 or panel control unit M20. The identification information managing unit 412 associates the received newly registered login password with the user information (user name and the like) and stores the same in the user identification information file 442, as the new user identification information.

The history information managing unit 414 manages the history information file 444. Specifically, the history information managing unit 414 transmits the history information, which is associated with the login password for which the login is permitted by the identification information managing unit 412, to the printer driver unit N20 or panel control unit M20 that is the transmission source of the login password. Also, the history information managing unit 414 receives the updated history information from the printer driver unit N20 or panel control unit M20 and updates the contents of the history information file 444. In this exemplary embodiment, the driver program 342 and the panel control program 242 are examples of a computer program. Further, the multi-function device 200 in this exemplary embodiment is an example of an image processing apparatus. Still further, the storage device 240 and the storage device 340 in this exemplary embodiment are examples of a managing unit.

### A-2. Descriptions of Performance Table, Condition Function Correspondence Table and Circumstance List Table

In the below, the performance table 346, the condition function correspondence table 343 and the circumstance list table 344 of the user computing device 300 and the multi-function device 200 are sequentially described.

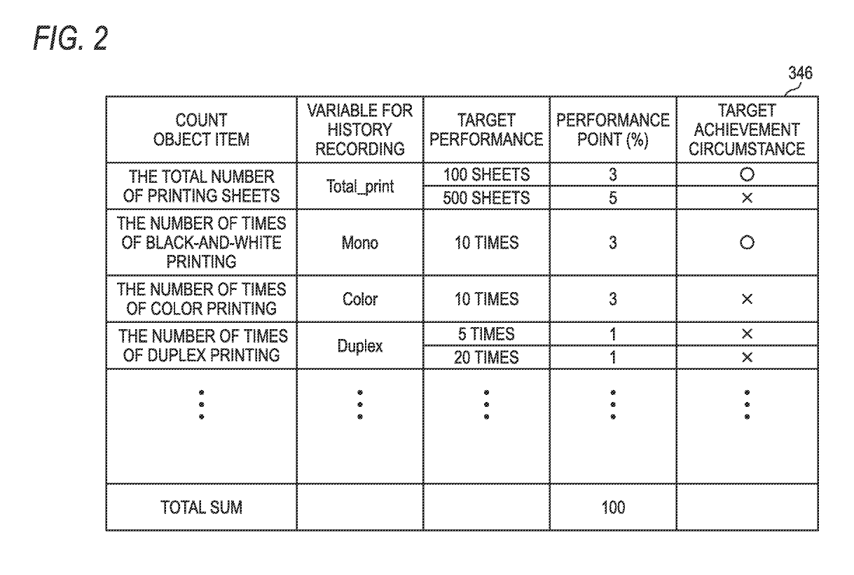

FIG. 2 shows an outline of the performance table. The performance table 346 is a table that is referred to by the performance display control unit N27. The performance table 346 includes columns of a count object item, a variable for history recording, a target performance, a performance point and a target achievement circumstance.

The column of the count object item describes a plurality of items (count object items) that should be counted as execution performance (execution history) of the printing function. For example, as shown in FIG. 2, the count object item includes ‘the total number of printing sheets’, ‘the number of times of black-and-white printing’, ‘the number of times of color printing’ and ‘the number of times of duplex printing.’ Like this, the count object item includes the items for each function (for example, ‘the number of times of black-and-white printing’, ‘the number of times of color printing’ and ‘the number of times of duplex printing’) for which the number of using times is counted for each of the printing functions (for example, black-and-white printing function, duplex printing function and color printing function). Also, the count object item includes a general item (for example, ‘the total number of printing sheets’) for which the number of printing sheets is counted irrespective of the types of the printing functions.

The column of the variable for history recording describes variables (variables indicating any one of the number of using times of the printing function and the number of printing sheets by the printing function) for counting the count object items. In FIG. 2, the variable ‘total_print’ for counting the total number of printing sheets, the variable ‘mono’ for counting the number of using times of the black-and-white printing function and the like are shown.

The column of the target performance describes target performances that at least one target performance is associated with one count object item. In FIG. 2, two target performances ('100 sheets' and ‘500 sheets’) are associated with the total number of printing sheets and one target performance (ten times) is associated with the number of times of black-and-white printing. The target performances, which are associated with the items for each function such as ‘the number of times of black-and-white printing’ and ‘the number of times of duplex printing’, can be said as the target performances for each function that are set for the specific printing functions such as black-and-white printing function and duplex printing function.

The column of the performance point describes the performance points that one performance point is associated with each target performance. The values of the performance points are set such that a total of all the performance points becomes 100.

The column of the target achievement circumstance describes whether an actual execution performance reaches each target performance, for each of the target performances.

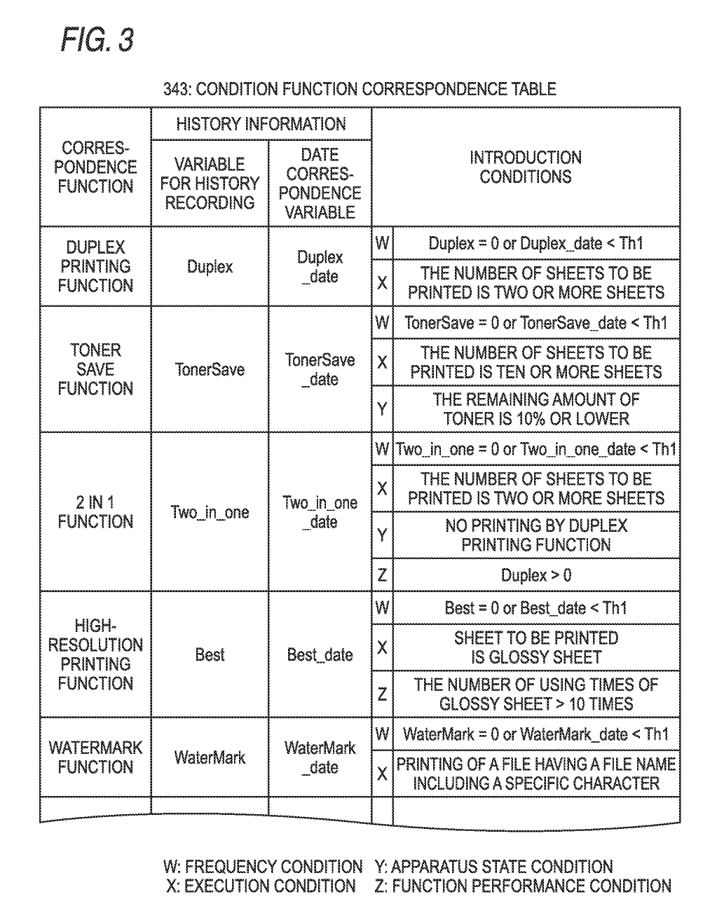

FIG. 3 shows an example of the condition function correspondence table. The condition function correspondence table 343 is a table that is referred to by the get unit N22. The condition function correspondence table 343 includes columns of a printing function (which is also referred to as correspondence function) of the printing execution unit 280, history information (the variable for history recording and the date correspondence variable) and an introduction condition, and the correspondence function, the history information and the introduction condition are described with associated with each other.

The column of the correspondence function describes printing functions. In FIG. 3, a variety of functions such as duplex printing function, toner save function, 2 in 1 function, high-resolution printing function and watermark function are described.

The column of the variable for history recording describes the variables indicating any one of the number of using times of the correspondence function (printing function) and the number of printing sheets by the printing function, as described above. In FIG. 3, the variable ‘Duplex’ for counting the number of using times of the duplex printing function, the variable ‘TonerSave’ for counting the number of using times of the toner save function and the like are described.

The column of the date correspondence variable describes variables indicating numerical values (for example, numerical values indicated by UNIX time (UNIX is a registered trademark) indicating date at which the correspondence function was used for the last time. In FIG. 3, the variable ‘Duplex_date’ indicating the numerical value indicating date at which the duplex printing function was used for the last time, the variable ‘TonerSave_date’ indicating the numerical value indicating date at which the toner save function was used for the last time, and the like are described.

The column of the introduction condition describes introduction conditions (frequency condition W, execution condition X, apparatus state condition Y and function performance condition Z) for introducing the correspondence function associated with the introduction conditions to a user in the assist mode printing processing (which will be described later). In FIG. 3, the column of the introduction condition corresponding to the duplex printing function describes only the frequency condition W and execution condition Z, and the column of the introduction condition corresponding to the toner save function describes the frequency condition W, the execution condition X and the apparatus state condition Y. The introduction condition necessarily includes the frequency condition W and the execution condition X. The introduction condition is determined satisfied when all the conditions included therein are satisfied.

The frequency condition W is a condition that is satisfied when the using frequency of the correspondence function associated with the introduction condition is smaller than a predetermined value. Specifically, the frequency condition W is a condition that is satisfied when a value of the variable for history recording is smaller than a threshold (for example, a value of the variable for history recording is zero) and/or when a value of the date correspondence variable is smaller than a threshold. For example, as shown in FIG. 3, the frequency condition W of the introduction condition, which is associated with the duplex printing function, is a condition that is satisfied when the variable for history recording ‘Duplex’ is zero (0) and/or when the date correspondence variable ‘Duplex_date’ is smaller than a threshold Th1. Regarding the threshold Th1 that is used in the determination of the frequency condition W, a numerical value indicating the past date (for example, one year ago) going back from a numerical value indicating the present date (for example, numerical value indicated by UNIX time) is used. As a result, the frequency condition W can be said as a condition that is satisfied when predetermined time has elapsed (for example, one or more years have elapsed) from the date at which the correspondence function was used for the last time.

The execution condition X is a condition that is satisfied when a user designates a specific printing instruction through a setting screen (which will be described later). For example, as shown in FIG. 3, the execution condition X of the introduction condition, which is associated with the duplex printing function and 2 in 1 function, is a condition that is satisfied when a printing instruction by which the number of printing sheets becomes two or more is included in the printing instruction from the user.

The apparatus state condition Y is a condition that is satisfied when a state of the multi-function device 200 is under specific state. For example, the apparatus state condition Y of the introduction condition, which is associated with the toner save function, is a condition that is satisfied when a remaining amount of the printing material (toner) of the multi-function device 200 is 10% or lower, as shown in FIG. 3.

The function performance condition Z is a condition that is satisfied when the execution performance of the specific function is a specific level or higher. For example, the function performance condition Z of the introduction condition, which is associated with the 2 in 1 function, is a condition that is satisfied when a value of the variable for history recording ‘Duplex’, which is an index indicating the execution performance of the duplex printing function, is larger than zero (0), as shown in FIG. 3.

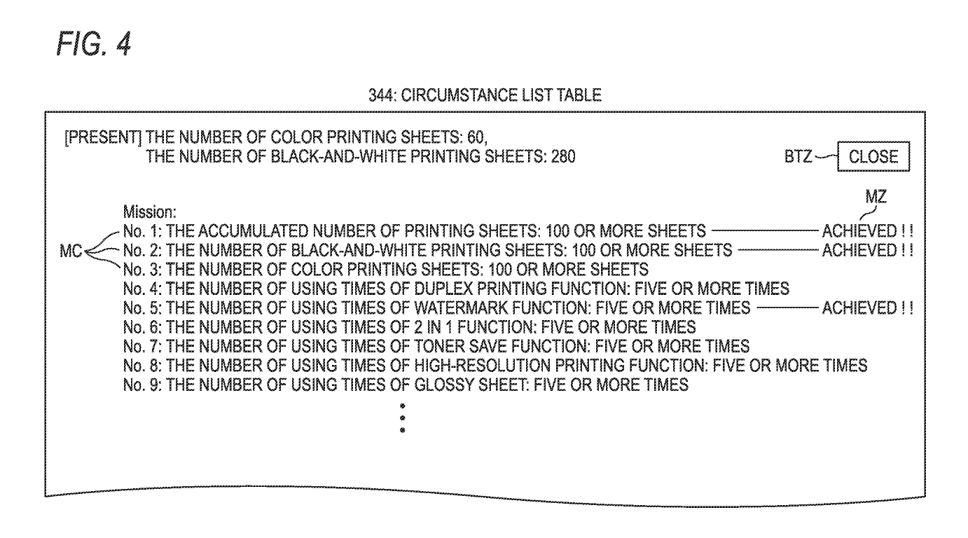

FIG. 4 shows an example of the circumstance list table. The circumstance list table 344 includes a plurality of sentences MC. One sentence MC is a sentence expressing content of the target performance relating to the specific printing function described in the performance table 346. Also, the circumstance list table 344 includes a sentence MZ (‘achieved!!’ in this exemplary embodiment) that is associated with a sentence of the sentences MC expressing the target performance achieved already. The sentence MZ indicates that the target performance expressed by the associated sentence MC has been already achieved. In this exemplary embodiment, the circumstance list table 344 displays the contents of all the target performances set in the performance table 346 and whether the target performances have been already achieved so that the user can distinguish them.

### A-3. Operations of Driver Program 342

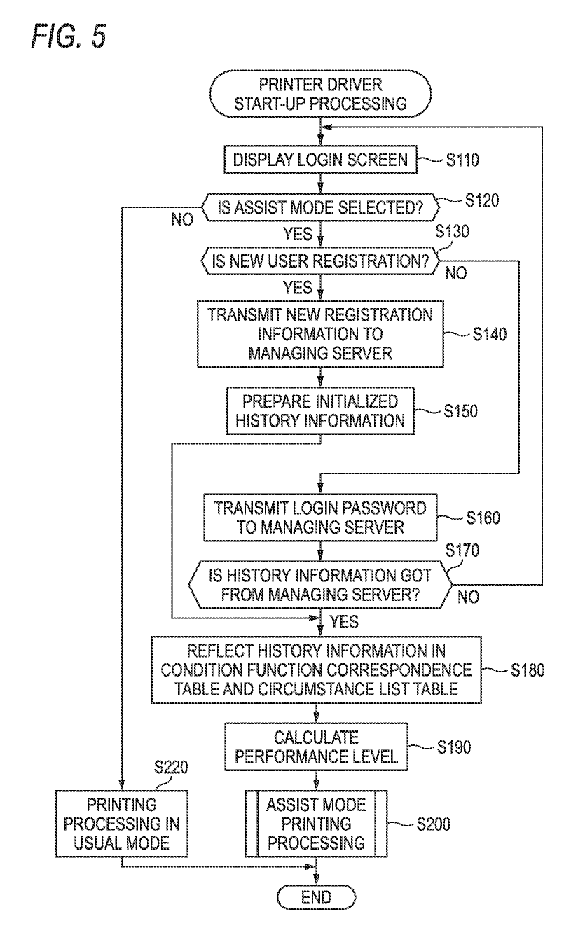

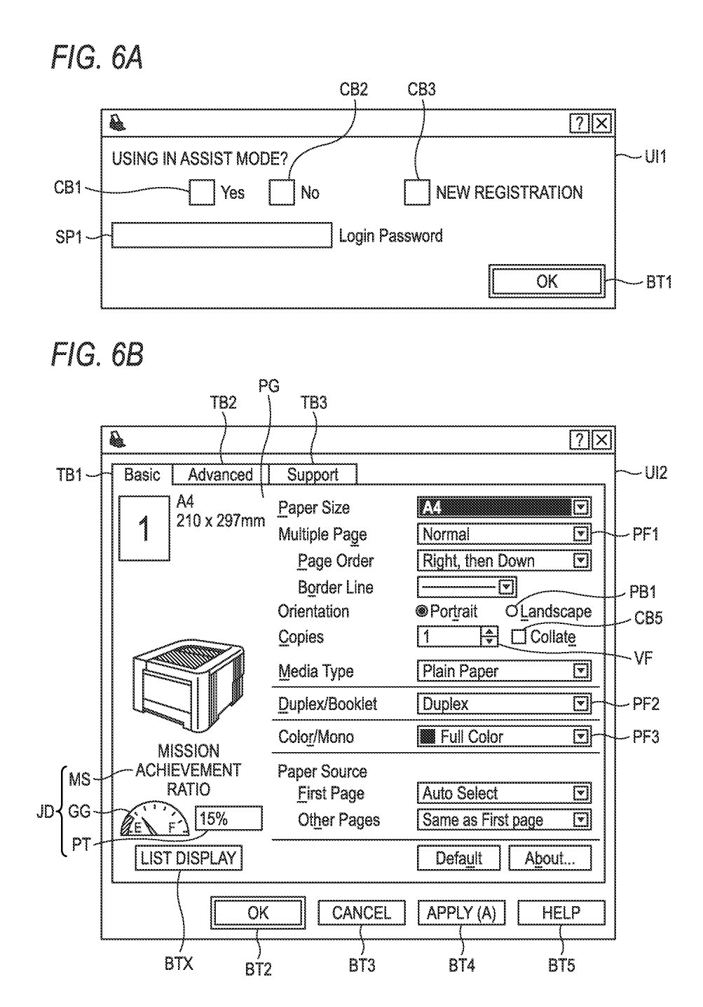

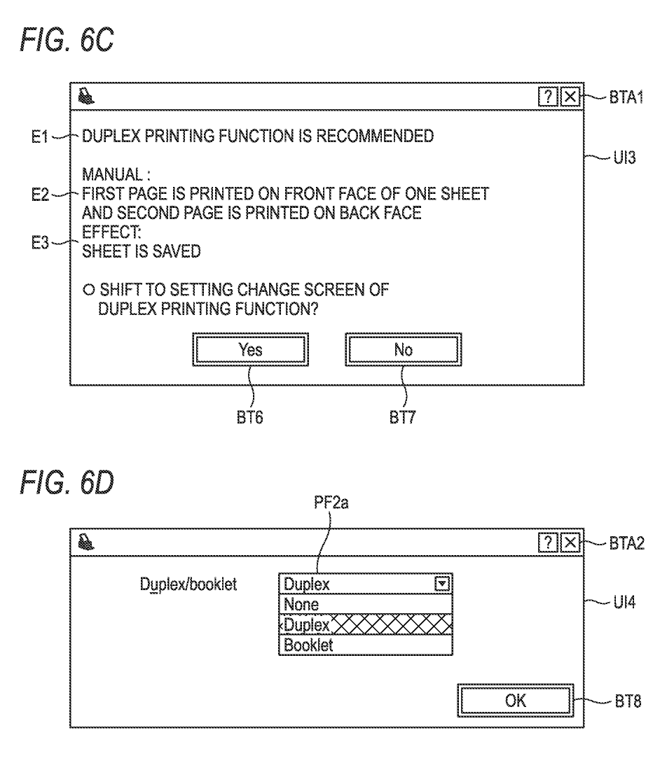

FIG. 5 is a flowchart showing printer driver start-up processing. FIGS. 6A to 6D show examples of an operation screen that is provided by the printer driver unit N20. The printer driver start-up processing starts when a user makes a printing instruction while the application execution unit N10 executes an application, for example.

When the printer driver start-up processing starts, the setting screen display control unit N21 of the printer driver unit N20 displays a login screen on the display unit 360 (step S110). FIG. 6A shows a login screen UI1. The login screen UI1 includes three check boxes CB1 to CB3, a password input field SP1 and an input completion button BT1. The first check box CB1 is checked when using an assist mode. The second check box CB2 is checked when not using an assist mode. The third check box CB3 is checked when making new user registration. In the password input field SP1, a password that is user identification information is input. The user checks the check boxes C131 to CB3, inputs an appropriate password in the password input field SP1 and operates (for example, clicks) the input completion button BT1, so as to input desired information.

In step S120, the setting screen display control unit N21 determines whether the user selects an assist mode. That is, when the input completion button BT1 is operated on the login screen UI1 at a state in which the first check box CB1 is checked, the setting screen display control unit N21 determines that the assist mode is selected. On the other hand, when the input completion button BT1 is operated on the login screen UI1 at a state in which the second check box CB2 is checked, the setting screen display control unit N21 determines that a usual mode is selected (the assist mode is not selected).

When the usual mode is selected (step S120: No), the printer driver unit N20 executes printing processing in the usual mode (step S220) and ends the processing. The description of the printing processing in the usual mode is omitted.

When the assist mode is selected (step S120: Yes), the identification information get unit N28 determines whether the new registration of the user is selected (step S130). That is, when the input completion button BT1 is operated on the login screen UI1 at a state in which the third check box CB3 is checked, the identification information get unit N28 determines that the new registration is selected. On the other hand, when the third check box CB3 is not checked, the identification information get unit N28 determines that the new registration is not selected.

When it is determined that the new registration is selected (step S130: Yes), the identification information get unit N28 gets new registration information from the user and transmits the same to the server 400. Specifically, the identification information get unit N28 gets the login password, which is input in the password input field SP1 on the login screen UI1, and transmits the same to the server as the new registration information. Also, the identification information get unit N28 may get the other new registration information such as user name and user ID and transmit the same to the server together with the login password, as the new registration information. In this case, the identification information get unit N28 displays a new registration screen (not shown) for getting the above information from the user on the display unit 360. The identification information managing unit 412 of the server 400 stores and manages the received new registration information in the user identification information file 442.

When the new registration information is transmitted, the printer driver unit N20 prepares initialized history information (a set of the variable for history recording and data correspondence variable of the initial value) for the newly registered user (step S150). When the initialized history information is prepared, the printer driver unit N20 proceeds to step S180.

When it is determined that the new registration is not selected (step S130: No), the identification information get unit N28 gets the login password, which is input in the password input field SP1 on the login screen UI1, and transmits the same to the server 400 (step S160).

In step S170, the history information get unit N23b of the printer driver unit N20 determines whether the history information is got, as a response to the login password transmitted in step S160. When the transmitted login password is correct, since the server 400 transmits the history information corresponding to the login password, as a response, the history information get unit N23b can get the corresponding history information. On the other hand, when the transmitted login password is not correct, the history information get unit N23b cannot get the history information from the server 400. The history information can be said as information indicating the past printing performance of the user specified by the login password.

When the history information cannot be got (step S170: No), the printer driver unit N20 determines that the login has failed, returns to step S110 and displays the login screen UI1 on the setting screen display control unit N21. On the other hand, when the history information is got (step S170: Yes), the printer driver unit N20 proceeds to step S180.

In step S180, the history information get unit N23b reflects the history information got from the server 400 in step S170 or the initialized history information prepared in step S150 in the condition function correspondence table 343 and the performance table 346. Specifically, based on the history information, the history information get unit N23b updates the variable value in the column of the variable for history recording and the variable value in the column of the date correspondence variable in the condition function correspondence table 343 (FIG. 3) and the variable value in the column of the variable for history recording and the content in the column of the target achievement circumstance in the performance table 346 (FIG. 2).

In step S190, the printer driver unit N20 calculates performance level based on the performance table 346 (FIG. 2). Specifically, the printer driver unit N20 calculates a summed value of the performance points (performance points achieved already) associated with the target performances achieved already, as a value indicating the performance level. The target performance achieved already is a target performance that the execution performance indicated by the history information (variable for history recording) has been already achieved, among the plurality of target performances described in the performance table 346 (FIG. 2). As described above, the plurality of target performances includes the target performances for each function, which are set for the specific printing functions such as black-and-white printing function and duplex printing function. The target performances for each function cannot be achieved unless there is the execution performance of the specific printing function. As a result, if there is no execution performance of the specific printing function, even though the execution performances of the other printing functions are largely accumulated, a value indicating the performance level (a summed value of the performance points (%) achieved already) reaches a limit and does not thus exceed a specific value. In other words, the upper limit of the value indicating the performance level is increased as the number of the executed printing functions, among the one or more specific printing functions for which the target performances for each function are set, is increased.

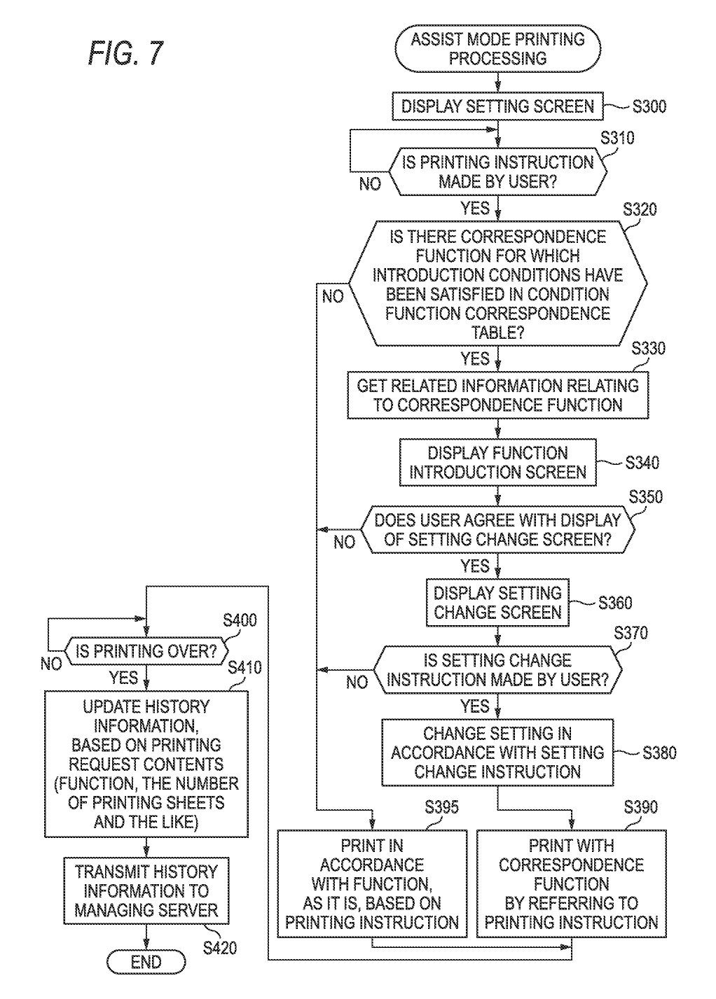

In step S200, the printer driver unit N20 executes assist mode printing processing. FIG. 7 is a flowchart showing the assist mode printing processing. In step S300, the setting screen display control unit N21 of the printer driver unit N20 displays an operation screen UI2 for receiving an execution instruction of the user on the display unit 360. At this time, the performance display control unit N27 displays the performance level on the operation screen UI2.

FIG. 6B shows the operation screen U12, which is one example of a setting screen. The operation screen UI2 includes a setting receiving page PG having display contents that can be switched by operating tabs TB1 to TB3 and main operation buttons BT2 to BT5 including an instruction decision button BT2, a printing stop button BT3 and the like.

As shown in FIG. 6B, the setting receiving page PG includes a plurality of input elements for receiving settings from the user with regard to a variety of setting items that can be applied when executing the printing function. The input elements include selection fields PF1 to PF3 enabling one of a plurality of selection items to be selectively input by using a pull-down menu, a radio button RB1, a check box CB5, a numerical value input field VF for inputting an integer value, and the like (FIG. 6B).

For example, the first selection field PF1 is an input element for inputting the number of pages that is printed on one surface of one sheet. That is, the first selection field PF1 is an input element for receiving an instruction indicating whether or not to execute the function of printing a plurality of pages on one surface (for example, 2 in 1 function, 4 in 1 function and the like). The second selection field PF2 is an input element for receiving an instruction indicating whether or not to execute the duplex printing function or booklet function. The third selection field PF3 is an input element for receiving a selection indicating whether to execute the color printing function or the black-and-white printing function.

The setting receiving page PG further includes a performance level display JD (FIG. 6B). The performance level display JD includes a message MS indicating a performance level display, an image GG visually indicating a degree of the performance level and a numerical value display PT indicating a degree of the performance level by a numerical value. As the image GG, an image that pictorially indicates a meter is used and a degree of the performance level is shown depending on a position of a meter pointer. The numerical value display PT is configured to display the value of the performance level (the summed value of the performance points achieved already) by using % (percent) as a unit.

Further, the setting receiving page PG includes a list display button BTX in the vicinity of the performance level display JD. Here, when the list display button BTX is pressed while the operation screen UI2 is displayed, the performance display control unit N27 of the printer driver unit N20 displays a screen, which indicates the circumstance list table 344 indicating the circumstance of the user's execution performance, on the display unit 360 separately from the operation screen UI2. Incidentally, when a closing button BTZ is pressed on the screen indicating the circumstance list 344, the performance display control unit N27 ends the display of the screen indicating the circumstance list 344.

In step S310, the setting screen display control unit N21 determines whether the user makes the printing instruction. Specifically, when the instruction decision button BT2 of the operation screen UI2 is pressed, it is determined that the user makes the printing instruction. When the user has not made the printing instruction (step S310: No), the printer driver unit N20 stands by until the printing instruction is made.

When the user makes the printing instruction (step S310: Yes), the get unit N22 determines whether there is the correspondence function for which the introduction condition is satisfied, by the condition function correspondence table 343 (FIG. 3), based on the printing instruction made by the user (step S320). Specifically, the get unit N22 first determines whether the frequency condition W of the respective introduction conditions is satisfied or not. When the frequency condition W is satisfied, the get unit continues to determine whether the execution condition X is satisfied based on the printing instruction from the user. When it is determined that the frequency condition W and the execution condition X are satisfied, the get unit N22 determines whether the apparatus state condition Y and the function performance condition Z are satisfied, if the corresponding conditions exist. At a point of time at which it is determined that the frequency condition W is not satisfied, the get unit N22 determines that the introduction condition is not satisfied. Also, at a point of time at which it is determined that the execution condition X is not satisfied even though the frequency condition W is satisfied, the get unit N22 determines that the introduction condition is not satisfied. Also, even though the frequency condition W and the execution condition X are satisfied, when it is determined that any one of the apparatus state condition Y and the function performance condition Z is not satisfied, the get unit N22 determines that the introduction condition is not satisfied.

For example, a case is assumed in which the variable for history recording ‘Two_in_one’ is 0 (zero), the variable for history recording ‘Duplex’ is larger than 0 (zero), and the printing instruction made by the user includes a printing instruction in the usual printing function, other than the duplex printing function and 2 in 1 function, and a printing instruction by which the number of printing sheets becomes five. In this case, since all the four conditions (frequency condition W, execution condition X, apparatus state condition Y and function performance condition Z) of the introduction conditions in which the associated correspondence function is 2 in 1 function are satisfied, it is determined that there is the correspondence function (2 in 1 function) for which the introduction conditions are satisfied.

When there is the introduction condition for which it is determined that all the conditions included therein are satisfied, the get unit N22 determines that there is the correspondence function for which the introduction conditions are satisfied (step S320: Yes) and gets the related information 345 relating to the correspondence function from the storage device 340 (step S330). The related information 345 includes information recommending the correspondence function (which is also referred to as recommendation information), information indicating a manual of the correspondence function (which is also referred to as manual information) and information of one or more setting change screens for changing the settings of the correspondence function, a navigation moving picture (navigation screen) for instructing a method of changing the setting of the correspondence function and the like.

In step S320, when the get unit N22 determines that there is no correspondence function for which the introduction conditions are satisfied (step S320: No), the printer driver unit N20 proceeds to step S395. In step S395, the printer driver unit N20 transmits a printing request to the multi-function device 200 (printing execution unit 280) so as to execute the printing in accordance with the function, as it is, based on the printing instruction designated by the user. Specifically, the printer driver unit N20 gets the setting contents of the setting items on the operation screen UI2 displayed in step S300. The printer driver unit N20 gets image data that is the printing object from the application execution unit N10. The printer driver unit N20 generates printing data for printing the image data, which is the printing object, in accordance with the got setting contents, and transmits the printing data to the multi-function device 200, as the printing request. Incidentally, when the user instructs the printing operation, the printer driver unit N20 ends display of a setting change screen U14.

In step S340, the each user display control unit N23a2 displays a function introduction screen U13 for introducing the correspondence functions based on the got related information 345. FIG. 6C shows the function introduction screen UI3, as an example of the function introduction screen. The function introduction screen UI3 includes recommendation information E1, manual information E2, effect information E3, a permission button BT6 that permits a shift to the setting change screen for changing the setting of the correspondence function, a refusal button BT7 that refuses the shift to the setting change screen and a screen display ending button BTA1. In the example shown in FIG. 6C, the recommendation information E1 is information for recommending the duplex printing function. The manual information E2 is information indicating the manual of the duplex printing function. The effect information E3 is information indicating an effect of the duplex printing function.

In step S350, the each user display control unit N23a2 determines whether the user agrees with the display of the setting change screen. Specifically, the each user display control unit N23a2 determines that the user agrees with the display of the setting change screen when the user presses the permission button BT6 and determines that the user does not agree with the display of the setting change screen when the user presses the refusal button BT7. Incidentally, even when the screen display ending button BTA1 located at an upper-right position on the function introduction screen UI3 is pressed, the each user display control unit N23a2 determines that the user does not agree with the display of the setting change screen.

When the user does not agree with the display of the setting change screen (step S350: No), the printer driver unit N20 proceeds to step S395.

When the user agrees with the display of the setting change screen (step S350: Yes), the each user display control unit N23a2 displays the setting change screen UI4 (step S360). FIG. 6D shows the setting change screen UI4. The setting change screen UI4 includes a selection field PF2a that enables one of a plurality of selection items to be selectively input by using a pull-down menu, a permission button BT8 that permits the setting change of the correspondence function and a screen display ending button BTA2 that is located at an upper-right position on the setting change screen UI4. In the example of FIG. 6D, the selection field PF2a is an input element that receives an instruction indicating whether to set the duplex printing function or the booklet function.

In step S370, the each user display control unit N23a2 determines whether the user makes the setting change instruction. Specifically, the each user display control unit N23a2 determines that the setting change instruction, which indicates that the setting of the correspondence function is changed into a setting selected in the selection field PF2a, is made when the user presses the permission button BT8. When the user presses the screen display ending button BTA2, the each user display control unit N23a2 determines that the setting change instruction by the user is not made (step S370: No) and proceeds to step S395. The example of FIG. 6D shows a state in which ‘Duplex’ is designated in the selection field PF2a, i.e., the duplex printing function is designated.

When the each user display control unit N23a2 determines that the setting change instruction by the user is made (step S370: Yes), the setting change unit N25 changes the setting of the setting item in response to the setting change instruction (step S380). In this case, the changed content of the setting item is reflected in the setting on the operation screen UI2. In the example of FIG. 6D, the setting is changed so that the duplex printing function is selected when performing the printing operation.

The printer driver unit N20 proceeds to step S390. In step S390, the printer driver unit N20 refers to the printing instruction (for example, the number of printing sheets and the like) made in step S310 and transmits the printing request to the multi-function device 200 (printing execution unit 280) so that the printing is executed with the function (correspondence function) after the setting change. Specifically, the printer driver unit N20 gets the setting content that is the setting content of the setting item on the operation screen UI2 and in which the setting change of the setting item is reflected in step S380. The printer driver unit N20 gets the image data that is the printing object from the application execution unit N10. The printer driver unit N20 generates printing data for printing the image data, which is the printing object, in accordance with the got setting content, and transmits the printing data to the multi-function device 200, as the printing request. Incidentally, when the user instructs the printing operation, the printer driver unit N20 ends display of the setting change screen U14.

In step S400, the printer driver unit N20 determines whether the multi-function device 200 has completed the printing based on the printing request made in step S390 or step S395. Specifically, when a notification indicating that the printing is completed is received from the multi-function device 200, the printer driver unit N20 determines that the multi-function device 200 has completed the printing operation. When the multi-function device 200 has not completed the printing operation (step S400: No), the printer driver unit N20 stands by until the printing operation is completed.

When the multi-function device 200 has completed the printing operation (step S400: Yes), the history information get unit N23b updates the user's history information based on the printing request content (which can be said as the content of the completed printing) (step S410). Specifically, the history information get unit N23b updates the value of the variable for history recording (refer to FIGS. 2 and 3) corresponding to the printing request content. Here, the plurality of variables for history recording may be updated in response to one printing request. For example, when the printing request content is the printing that uses both the black-and-white printing function and the duplex printing function, the variable Total print relating to the total number of printing sheets, the variable Mono relating to the number of times of the black-and-white printing and the variable Duplex relating to the number of times of the duplex printing are updated. Also, the history information get unit N23b updates the value of the date correspondence variable to a numerical value indicating the present date. Incidentally, even when the user does not agree with the display of the setting change screen (S350: No), the numerical value of the date correspondence variable corresponding to the function (correspondence function) introduced on the function introduction screen may be updated to the numerical value indicating the present date. According thereto, it is possible to prevent a case, in which the function introduction screen (function introduction screen introduced previously) relating to the same function is repeatedly displayed even though the user does not desire the display, from being occurred.

In step S420, the identification information get unit N28 transmits the updated history information to the server 400 and ends the assist mode printing processing. The history information managing unit 414 of the server 400 updates the content of the history information file 444 based on the history information received from the identification information get unit N28. As a result, the execution performance of the printing function of the multi-function device 200 by the user is managed for each user in the server 400.

In the above, the specific operations of the printer driver unit N20 of the user computing device 300 have been described. However, the panel control unit M20 of the multi-function device 200 may perform the same operations so as to realize the same operations and effects. In this case, the printing request that is transmitted from the panel control unit M20 to the printing control unit M10 is an instruction command that enables the printing execution unit 280 to print the printing data based on the got image data. Also, the content (FIGS. 4 and 6) that is displayed on the display unit 360 of the user computing device 300 by the panel control unit M20 is displayed on the display panel 260 of the multi-function device 200 by the panel control unit M20. Incidentally, when the printing control unit M10 gets the image data, which is the printing target, from the scanner unit 290 and generates the printing data, based on the image data, i.e., when the printing control unit M10 executes the copying function, the corresponding copying function may be managed for each user, as the execution performance of the printing function.

According to the above-described exemplary embodiment, in the assist mode printing processing, the related information 345 (related information 245) associated with the correspondence function having the using frequency lower than the predetermined value (for which the frequency condition W is satisfied), as the correspondence function for which the associated introduction conditions are satisfied, is displayed on the display unit 360 (display panel 260). According thereto, when the specific printing instruction is designated from the user, the predetermined related information is displayed. Accordingly, it is possible to enable the user to recognize the effective related information at the timing at which the user instructs the printing. Hence, the using of the printing function (correspondence function) can be promoted by the user. As a result, it is possible to suppress the printing functions of the multi-function device 200 from being unused. Also, since the related information, which corresponds to the execution condition at the time when the user instructs the printing, is displayed, the user can easily know whether or not to use the printing functions indicated by the related information under which circumstances.

According to the above-described exemplary embodiment, when any one of the apparatus state condition Y and the function performance condition Z is satisfied, which is a case where the frequency condition W and the execution condition X are satisfied, the related information 345 (related information 245) of the correspondence functions associated with the introduction condition (FIG. 3) including the corresponding condition is displayed on the display panel 360 (display panel 260). According thereto, the related information displayed on the display unit becomes the information that the user much desires, so that the using of the printing function (correspondence function associated with the related information) of the multi-function device 200 (printing execution unit 280) can be further promoted.

According to the above-described exemplary embodiment, when the user computing device 300 executes the assist mode printing processing, the setting screen (FIG. 6D: setting change screen UI4) of the setting items of the correspondence function is displayed on the display unit 360, as the related information of the correspondence function. Then, when the user instructs the setting change, the setting of the setting item of the correspondence function relating to the related information is changed based on the setting change instruction. According thereto, when making the printing instruction, the user can execute the setting change of the setting items of the correspondence function, in accordance with the related information (setting change screen UI4) relating to the correspondence function. As a result, since the user can easily change the settings of the setting items of the correspondence function into the desired settings, the using of the printing function (correspondence function) of the multi-function device 200 by the user can be promoted.

According to the above-described exemplary embodiment, the image GG and the numerical value PT indicating the performance level corresponding to the execution performances of the printing functions (black-and-white printing function, color printing function, duplex printing function and the like) are displayed on the display unit 360 (display panel 260) (FIG. 6B). Therefore, it is possible to provide the user with the incentive for the using of the plurality of printing functions. As a result, the using of the printing functions of the multi-function device 200 by the user can be promoted. Also, the upper limit of the performance level indicated by the image GG and the numerical value PT is increased as the number of the printing functions, which was previously executed by the logged-in user, is increased. Accordingly, in order to enable the printer driver unit N20 to display the image GG and the numerical value PT indicating the higher performance level, the user is required to enable the multi-function device 200 to execute the more printing functions. As a result, it is possible to provide the user with the incentive for the using of the more printing functions, so that the using of the printing functions of the multi-function device 200 by the user can be further promoted.

According to the above-described exemplary embodiment, when the using frequency of the specific printing function (correspondence function) by the specific user who is the user identified by the login password is lower than the predetermined value, the related information relating to the corresponding printing function is displayed on the display unit 360 (display panel 260), as the information that is provided to the identified user. That is, the related information relating to the printing function is selectively displayed for the user of the plurality of users using the multi-function device 200, by whom the using frequency of the specific printing function (correspondence function) is lower than the predetermined value. Therefore, the using of the specific printing function is promoted by the user by whom the using frequency of the specific printing function is lower than the predetermined value, so that the using of the printing functions of the multi-function device 200 by the plurality of users can be promoted.

According to the above-described exemplary embodiment, the circumstance list table 344 (circumstance list table 244) is displayed for the user (FIG. 4). The circumstance list table includes the display of the contents of the target performances including the target performances for each of the functions and the display indicating whether the target performances have been achieved already. As a result, the user can easily recognize the method of increasing the performance level.

Incidentally, according to the above-described exemplary embodiment, in the assist mode printing processing (FIG. 7), one setting of the correspondence function is changed. However, in the assist mode printing processing, a plurality of setting items, i.e., two setting items, of the correspondence functions may be changed. This example will be described below.

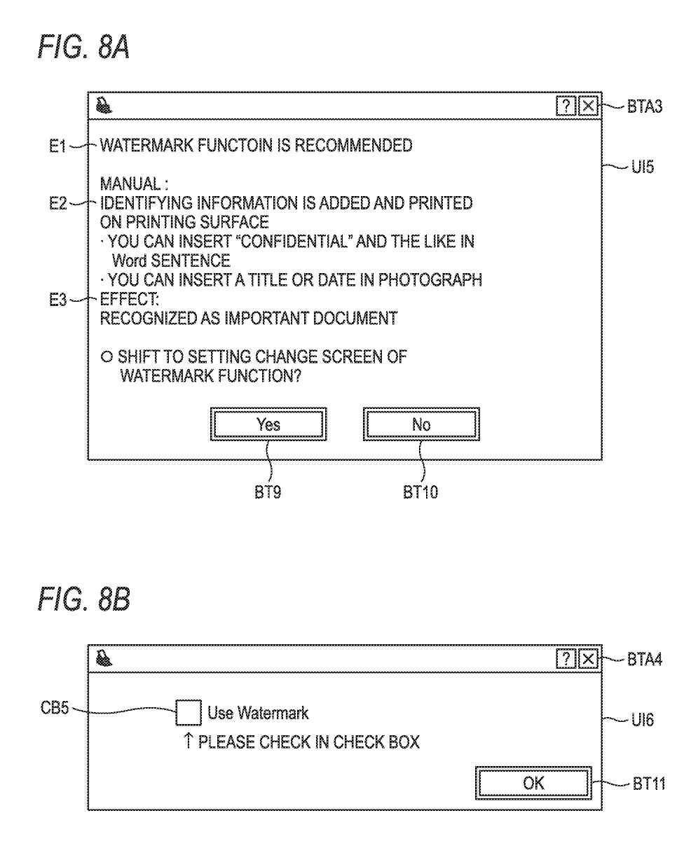

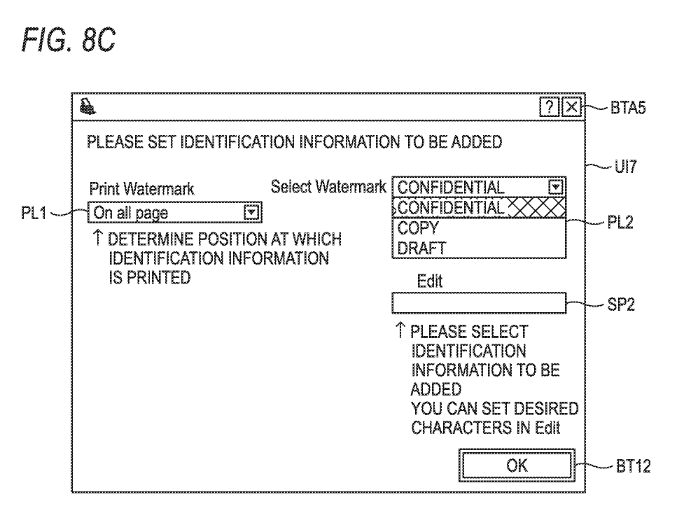

FIGS. 8A to 8C show an operation screen when two setting items of the correspondence functions are changed. The plural setting screen display control unit N23ai displays a function introduction screen UI5 for introducing the correspondence function based on the related information 345 got in step S330 of the assist mode printing processing (FIG. 7) (step S340). FIG. 8A shows the function introduction screen UI5, as an example of the function introduction screen. The function introduction screen UI5 includes recommendation information E1, manual information E2, effect information E3, a permission button BT9 that permits a shift to the setting change screen for changing the setting of the correspondence function, a refusal button BT10 that refuses the shift to the setting change screen and a screen display ending button BTA3. In the example shown in FIG. 8A, the recommendation information E1 is information for recommending the watermark function. The manual information E2 is information indicating the manual of the watermark function. The effect information E3 is information indicating an effect of the watermark function.

In step S350, the plural setting screen display control unit N23a1 determines whether the user agrees with the display of the setting change screen. Specifically, the plural setting screen display control unit N23a1 determines that the user agrees with the display of the setting change screen when the user presses the permission button BT9 and determines that the user does not agree with the display of the setting change screen when the user presses the refusal button BT10. Incidentally, even when the screen display ending button BTA3 located at an upper-right position on the function introduction screen UI5 is pressed, the plural setting screen display control unit N23a1 determines that the user does not agree with the display of the setting change screen.

When the user does not agree with the display of the setting change screen (step S350: No), the printer driver unit N20 proceeds to step S395.

When the user agrees with the display of the setting change screen (step S350: Yes), the plural setting screen display control unit N23a1 displays the setting change screen UI6 (step S360). FIG. 8B shows the setting change screen UI6, as an example of the setting change screen. The setting change screen UI6 includes a check box CB5, a permission button BT11 that permits the setting change of the correspondence function and a screen display ending button BTA4 that is located at an upper-right position on the setting change screen UI6. In the example of FIG. 8B, the check box CB5 is an input element for setting the watermark function.

In step S370, the plural setting screen display control unit N23a1 determines whether the user makes the setting change instruction. Specifically, the plural setting screen display control unit N23a1 determines that the setting change instruction, which indicates that the setting of the correspondence function is changed into a setting to execute the watermark function, is made when the user presses the permission button BT11 at a state in which the check box CB5 is checked. When the user presses the screen display ending button BTA4, the plural setting screen display control unit N23a1 determines that the setting change instruction by the user is not made (step S370: No) and proceeds to step S395.

When the plural setting screen display control unit N23a1 determines that the setting change instruction by the user is made (step S370: Yes), the setting change unit N25 changes the setting of the setting item in response to the setting change instruction (step S380). In this case, the changed content of the setting item is reflected in the setting of the setting item on the operation screen U12. In the example of FIG. 8B, the setting is changed so that the watermark function is executed when performing the printing operation.

Here, the plural setting screen display control unit N23a1 again returns to step S360 and displays a setting change screen UI7 different from the setting change screen UI6. FIG. 8C shows the setting change screen UI7, as an example of the setting change screen. The setting change screen UI7 includes selection fields PL1, PL2 each of which enables one of a plurality of selection items to be selectively input by using a pull-down menu, an identification information input field SP2 with which identification information serving as a watermark can be input, a permission button BT12 that permits the setting change of the correspondence function and a screen display ending button BTA5 that is located at an upper-right position on the setting change screen UI7. In the example of FIG. 8C, the selection field PL1 is an input element that receives an instruction indicating to which page the watermark function is input. The selection field PL2 is an input element that receives a selection instruction indicating what type the identification information serving as a watermark is.

The plural setting screen display control unit N23a1 determines whether the user instructs the setting change, in second step S370. Specifically, the plural setting screen display control unit N23a1 determines that the setting change instruction, which indicates that the setting of the correspondence function is changed to a setting selected in the selection fields PL1, PL2, is made when the user presses the permission button BT12. When the user presses the screen display ending button BTA5, the plural setting screen display control unit N23a1 determines that the setting change instruction by the user is not made (step S370: No) and proceeds to step S395. In the example of FIG. 8C, ‘On all page’ is designated in the selection field PL1. Also, ‘CONFIDENTIAL’ is designated in the selection field PL2.

When the plural setting screen display control unit N23a1 determines that the setting change instruction by the user is made (step S370: Yes), the setting change unit N25 changes the setting of the setting item, in response to the setting change instruction (step S380). In this case, the changed content of the setting item is reflected in the setting on the operation screen UI2. In the example of FIG. 8C, the setting is changed so that the watermark is attached on all pages. Also, the setting is changed so that ‘CONFIDENTIAL’ is attached as the watermark.

According to the above-described exemplary embodiment, when the user computing device 300 executes the assist mode printing processing and thus the plurality of setting items can be set for the correspondence function, the plurality of correspondence setting screens (setting change screen UI6 and setting change screen UI7) for setting the respective items of the correspondence function is sequentially displayed on the display unit 360, as the related information. According thereto, when the user instructs the printing, the user can smoothly execute the setting change of the setting items of the correspondence function without confusion, in accordance with the related information (FIGS. 8B, 8C: setting change screens UI6, UI7) relating to the correspondence function sequentially displayed. In the above-described exemplary embodiment, two settings of the setting items of the correspondence function are changed. However, the invention is not limited thereto. For example, the setting change screens may be sequentially displayed and the settings of the three or more items of the correspondence function may be thus changed. Also, the user may be enabled to set the items of setting a position or angle at which the identification information set as the watermark is printed, other than the items shown in FIG. 8C.

### B. Modifications to Exemplary Embodiments

The invention is not limited to the above-described exemplary embodiments and can be implemented in various aspects without departing from the scope of the invention. For example, following modifications are also possible.

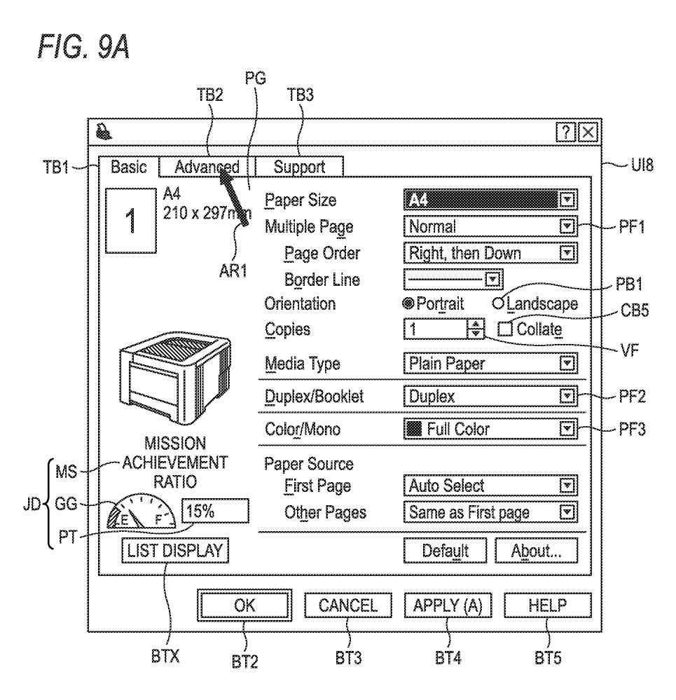

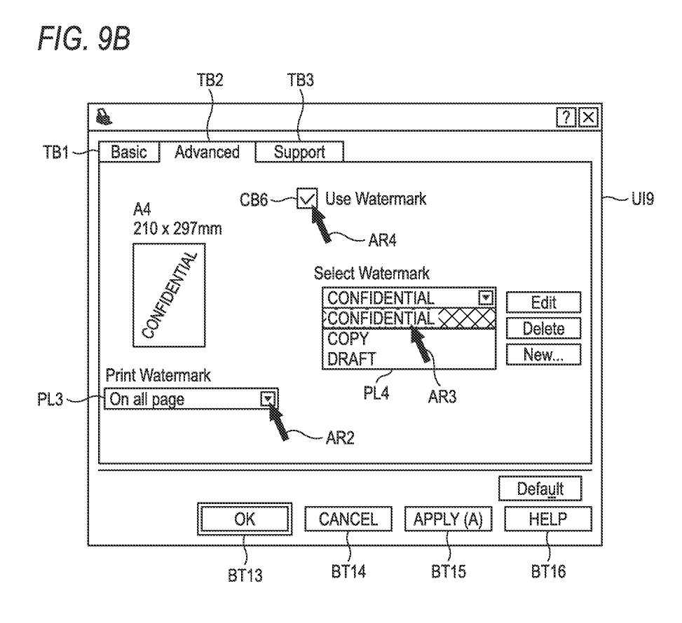

(1) FIGS. 9A and 9B illustrate a navigation moving picture as the related information, in a modified embodiment. In steps S340 to S380 of the assist mode printing processing (FIG. 7), the related information display control unit N23 may display a navigation moving picture including a navigation screen UI8 and a navigation screen U19 on the display unit 360 as the related information, instead of displaying the setting change screen as the related information. The navigation screen UI8 and the navigation screen UI9 are screens each of which provides the user with one scene for instructing the setting modes of one or more items of the correspondence function. In the below, processing is described in which the related information display control unit N23 displays the navigation moving picture.

The related information display control unit N23 starts to display the navigation moving picture at timing at which the related information is displayed (in step S340 and the like of the assist mode printing processing (FIG. 7)). Specifically, the related information display control unit N23 displays the navigation screen UI8 on the display unit 360. FIG. 9A shows the navigation screen U18, as an example of the navigation screen. The navigation screen UI8 is the basically same as the operation screen UI2 of FIG. 6B, and is different from the operation screen UI2 in that an arrow AR1 for sequentially instructing the user on the method of changing the setting of the correspondence function is indicated. The arrow AR1 indicates the tab TB2.

The related information display control unit N23 displays the navigation screen UI9 on the display unit 360 after the arrow AR1 presses the tab TB2. FIG. 9B shows the navigation screen UI9, as an example of the navigation screen. The navigation screen U19 shows a setting screen corresponding to the tab TB2 and includes selection fields PL3, PL4 each of which enables one of a plurality of selection items to be selectively input by using a pull-down menu, a check box CB6, main operation buttons BT13 to BT16 including a permission button BT13 that permits the setting change of the correspondence function and a cancel button BT14 that cancels the setting change, and arrows AR2 to AR4. In the example of FIG. 9B, the selection field PL3 is an input element that receives an instruction indicating to which page the watermark function is input. The selection field PL4 is an input element that receives a selection instruction indicating what type the identification information serving as a watermark is. The check box CB6 is an input element for setting the watermark function. The arrow AR2 indicates the selection field PL3, the arrow AR3 indicates the selection field PL4 and the arrow AR4 indicates the check box CB6.

After that, the related information display control unit N23 displays, in the navigation screen UI9, an aspect that the arrow AR2 selects one selection item in the selection field PL3, an aspect that the arrow AR3 selects one selection item in the selection field PL4 and an aspect that the arrow AR4 checks the check box CB6. The related information display control unit N23 deletes the arrows AR2 to AR4, displays an aspect that a new arrow presses the permission button BT13 and ends the navigation moving picture.

According to the above modified embodiment, in order to provide the user with the setting method of one or more items of the correspondence function, the navigation moving picture is displayed on the display unit 360, as the related information of the correspondence function. According thereto, when the user instructs the printing, the navigation moving picture is displayed to the user, so that the user is enabled to recognize the setting method of the setting items of the correspondence function in time series (sequentially). Meanwhile, in this modified embodiment, the related information display control unit N23 displays the navigation moving picture as the related information. However, the invention is not limited thereto and a still image expressing the navigation screen U18 or navigation screen UI9 may be displayed. In this case, when the user operates an arrow shown in the navigation screen UI8, the display may be switched to the navigation screen UI9.

(2) In the above-described exemplary embodiments, in the assist mode printing processing, when the introduction conditions are satisfied by the condition function correspondence table, the related information 345 relating to the correspondence function corresponding to the introduction condition is got from the storage device 340 and is displayed on the display unit 360, as it is. However, the invention is not limited thereto. For example, when the introduction conditions are satisfied, the related information 345 relating to the correspondence function corresponding to the introduction conditions may be got from the storage device 340, the got related information 345 may be subject to predetermined processing and the processed related information 345 may be displayed on the display unit 360, as the related information relating to the correspondence function. Further, when the introduction conditions are satisfied, the related information 345 relating to the correspondence function corresponding to the introduction conditions may be got from the storage device 340 and the other information associated with the got related information 345 may be displayed on the display unit 360, as the related information relating to the correspondence function.

(3) In the above-described exemplary embodiments, the assist mode printing processing is executed based on the history information that is managed for each user. However, the invention is not limited thereto. For example, while not managing the history information for each user, the history information of users using the multi-function device 200 may be managed without distinction and the assist mode printing processing may be executed based on the corresponding history information. According thereto, it is possible to omit the login related processing such as display of the login screen UI1, the managing processing of the user identification information (login password and the like) and the like. Thus, it is possible to promote the using of the multi-function device 200 with the simpler configuration.

(4) In the above-described exemplary embodiments, in the screen indicating the circumstance list 344 that is displayed when the list display button BTX (see FIG. 6B) is pressed, one sentence MC may be associated with the related information (for example, navigation moving picture or setting change screen) relating to the specific printing function corresponding to the sentence MC. For example, when the sentence MC is ‘the number of using times of the duplex printing function is five times or more’ (refer to FIG. 4: No. 4), the sentence MC may be associated with the navigation moving picture (related information) relating to the duplex printing function that is the printing function corresponding to the sentence MC. In this case, when the user selects one sentence MC (clicks one sentence MC) on the screen indicating the circumstance list 344, the performance display control unit N27 displays the related information associated with the sentence MC on the display unit 360. According thereto, the user can see the related information relating to the specific printing function without referring to an explanatory pamphlet (manual), a website and the like. Hence, it is possible to improve the user's satisfaction with the multi-function device 200.

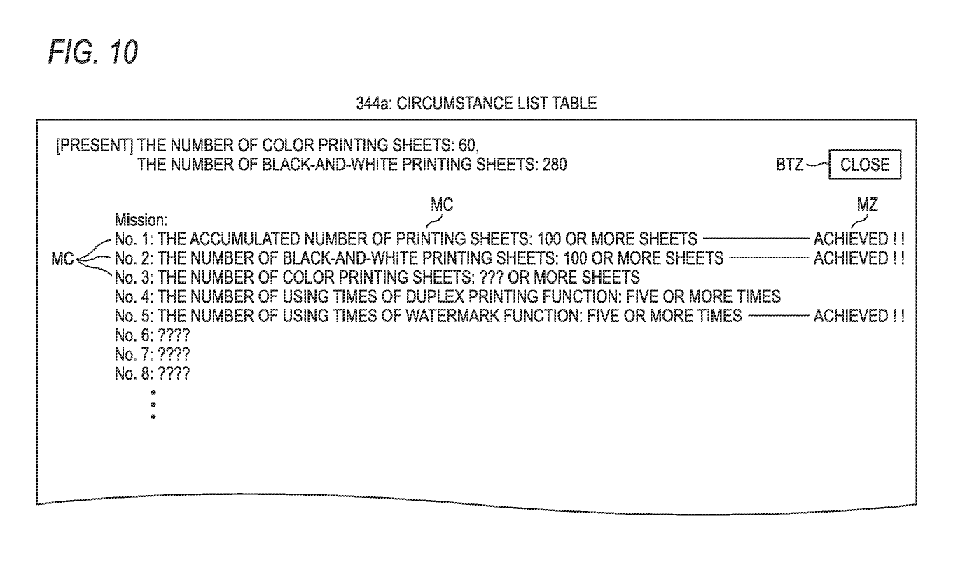

(5) FIG. 10 shows an example of a circumstance list table 344a in a modified embodiment. The printer driver unit N20 may display the circumstance list table 344a shown in FIG. 10 on the display unit 360, instead of the circumstance list table 344 shown in FIG. 4. In the circumstance list table 344a of this modified embodiment, among the plurality of sentences MC expressing the contents of the target performances, a part or all of the sentence of a target performance for which the execution performance of the user has not been achieved is not displayed. A part of the sentence, which is not displayed, is a specific target numerical value of the number of the printing sheets or the number of using times of the function, which is set as the target performance, for example. In the circumstance list table 344a, ‘? (question mark)’ is displayed, instead of the part or all of the sentence MC not displayed. The question mark is displayed, so that the user can recognize that there is the target performance not achieved yet but cannot recognize a part or all of the content.

According to this modified embodiment, the user can recognize that there is the target performance not achieved yet that the user cannot know a part or all of the content thereof. As a result, the inquiry desire of the user who wants to know the content of the target performance not achieved yet is stimulated, so that it is possible to urge the user to use the more printing functions.

(6) The image processing system 1000 according to the above-described exemplary embodiment may include the other one or more user computing devices 800, as shown in the dotted line of FIG. 1, in addition to the user computing device 300. A configuration of the other user computing device 800 is the same as that of the user computing device 300. In this case, the history information managing unit 414 of the server 400 preferably unifies the management of the history information from the respective printer driver units N20 of the user computing devices 300, 800, for each user.

According to this modified embodiment, even when the same user uses the printing functions of the multi-function device 200 through the user computing devices 300, 800, since the assist mode printing processing (FIG. 7) is executed for each user in accordance with the uniformly managed history information, it is possible to effectively promote the using of the printing functions for each user.

(7) The image processing system 1000 according to the above-described exemplary embodiment may include the other one or more multi-function devices 900, as shown in the dotted line of FIG. 1, in addition to the multi-function device 200. A configuration of the other multi-function device 900 is the same as that of the multi-function device 200. In this case, the history information managing unit 414 of the server 400 may unify the management of the history information of the multi-function devices 200, 900 for each user. According thereto, even when the same user uses the multi-function devices 200, 900 having the same printing functions, since the assist mode printing processing is executed by referring to the past history information of the same user, it is possible to effectively promote the using of the printing functions for each user.

(8) In the above-described exemplary embodiment, the multi-function device 200 capable of executing the printing functions is adopted. However, instead of the multi-function device, the other image processing apparatus may be adopted. The other image processing apparatus may include an image generation apparatus (digital camera, scanner and the like) that generates image data, which indicates an object, by using an optical device. For example, when a digital camera is adopted, it is possible to implement a user interface capable of promoting the using of imaging functions of the digital camera (for example, high-resolution imaging function, back light compensation, color correction function for each photographic subject (for example, color correction for person, color correction for landscape and the like), auto-focus function and manual focus function).

(9) The server 400 is not limited to an apparatus having one housing and may be configured by a computing system having a plurality of computing devices (for example, distributed computing system implementing a so-called cloud computing).

(10) In the above-described exemplary embodiment, the history information (execution performance) may be managed in the printer driver unit N20, instead of the server 400. Alternatively, the history information (execution performance) may be managed in the multi-function device 200. According thereto, it is possible to promote the using of the printing functions of the multi-function device 200 with a simple configuration.

(11) In the above-described exemplary embodiment, in the printer driver start-up processing, the login screen UI1 is displayed, so that the user identification information (login password) is got from the user. However, the invention is not limited thereto. For example, when a login password (which is also referred to as an OS password) is got from the user at the start-up time of an OS (Operating System) of the user computing device 300, the OS password got from the user may be used as the user identification information in the printer driver start-up processing.

(12) In the above-described exemplary embodiment, a part of the configuration implemented by the hardware may be replaced with software. On the contrary, a part of the configuration implemented by the software may be replaced with hardware.

What is claimed is:

1. A non-transitory computer-readable medium having a computer program stored thereon and readable by a computer for displaying a setting screen for inputting an execution instruction to an image processing apparatus configured to execute a plurality of functions relating to image processing, the computer program, when executed by the computer, causes a computer to perform operations comprising:
a first displaying process of displaying the setting screen on a display unit;
a getting process of getting information about a correspondence function from a managing unit,
wherein the managing unit manages a display condition including an execution condition, which is satisfied when a specific instruction is designated by a user through the setting screen, and the functions in association with each other, and
wherein the correspondence function is a function that is associated with the display condition; and
a second displaying process of, when a using frequency of the correspondence function is lower than a predetermined value, which is a case where the display condition is satisfied when the specific instruction is designated, displaying related information relating to the correspondence function on the display unit by using the got information relating to the correspondence function.

2. The program according to claim 1,
wherein the display condition comprises at least one of an apparatus state condition, which is satisfied when the image processing apparatus is under a specific state, and a function performance condition, which is satisfied when an execution performance of specific function of the plurality of functions is a specific level or higher.

3. The program according to claim 1,
wherein the second displaying process further comprises a correspondence-setting-screen displaying process of displaying, as the related information, a correspondence setting screen for setting a setting item of the correspondence function relating to the related information on the display screen, and
wherein the operations further comprise a changing process of, when the user instructs a setting change through the correspondence setting screen, changing a setting of the setting item of the correspondence function relating to the related information based on the setting change instruction.

4. The program according to claim 3,
wherein the correspondence-setting-screen displaying process comprises a process of, when a plurality of setting items can be set for the correspondence function, sequentially displaying a plurality of the correspondence setting screens for setting the plurality of items of the correspondence function, respectively, on the display unit as the related information.

5. The program according to claim 1, further comprising:
an executing process of enabling the image processing apparatus to execute a function of the plurality of functions instructed by the execution instruction, and
a performance-level displaying process of displaying performance level corresponding to execution performances of the plurality of functions.

6. The program according to claim 5,
wherein an upper limit of the performance level is increased as the number of executed functions of the plurality of functions is increased.

7. The program according to claim 1, further comprising:
a user-identification-information getting process of enabling the computer to get user identification information identifying a specific user of a plurality of users,
wherein frequency information indicating the using frequency of the plurality of functions is managed for each user by the managing unit,
wherein the execution condition is a condition that is satisfied when the execution instruction of an identified user, who is a user identified by the user identification information, includes the specific instruction, and
wherein the second displaying process comprises:
a process of getting, among the frequency information, the frequency information of the identified user in the correspondence function of the functions which is associated with the display condition; and
a process of, when the using frequency indicated by the got frequency information is lower than the predetermined value in a case where the display condition including the execution condition is satisfied, displaying the related information relating to the correspondence function corresponding to the got frequency information on the display unit as information about the identified user.

8. An image processing apparatus configured to execute a plurality of functions relating to image processing, the image processing apparatus comprising:
a display unit; and
a control device configured to:
control the display unit to display a setting screen for receiving an execution instruction of a user;
get information about a correspondence function from a memory,
wherein the control device is configured to manage a display condition including an execution condition, which is satisfied when a specific instruction is designated by the user through the setting screen, and the functions in association with each other in the memory, and
wherein the correspondence function is a function that is associated with the display condition; and
when a using frequency of the correspondence function is lower than a predetermined value, which is a case where the display condition is satisfied when the specific instruction is designated, control the display unit to display related information relating to the correspondence function on the display unit by using the got information relating to the correspondence function.
